(19) United States
(12) Patent Application Publication
(10) Pub. No.: US 2013/0140993 A1
(43) Pub. Date: Jun. 6, 2013

(54) FAILSAFE LIGHTING SYSTEM

(71) Applicants: Thomas Georg-Christian Theodor Buerrig, Hamburg (DE); Artur Lorenz Boebel, Hamburg (DE)

(72) Inventors: Thomas Georg-Christian Theodor Buerrig, Hamburg (DE); Artur Lorenz Boebel, Hamburg (DE)

(73) Assignee: KONINKLIJKE PHILIPS ELECTRONICS N.V., EINDHOVEN (NL)

(21) Appl. No.: 13/701,908

(22) PCT Filed: Jun. 1, 2011
(86) PCT No.: PCT/IB2011/052421

§ 371 Date: Dec. 4, 2012

(30) Foreign Application Priority Data
Jun. 8, 2010 (EP) 10165186.7

(51) Int. Cl. H05B 37/02

(52) U.S. Cl. CPC H05B 37/02
USPC 315/134; 315/151

(57) ABSTRACT

A failsafe lighting system (1) comprises a lamp (L) and monitoring circuitry for monitoring the correct functioning of the lamp (L), the monitoring circuitry comprising an optical sensor (26) positioned for receiving light generated by the lamp (L). The monitoring circuitry comprises a self-oscillating loop (25) which includes the lamp (L) and the optical sensor (26), wherein the optical path between the lamp (L) and the optical sensor (26) is an essential portion of the loop (25) such that the loop (25) can only oscillate if the optical sensor (26) receives sufficient light from the lamp (L).

### FIELD OF THE INVENTION

The present invention relates in general to lighting device for emitting light. Particularly, the present invention relates to safety lamps or warning lamps.

### BACKGROUND OF THE INVENTION

In the following, the phrase “lamp” will be used as a simple short phrase indicating a device capable of emitting light when receiving sufficient electrical power. Such lamp will have electrical terminals for connection to power. It is to be noted, though, that a lamp may actually include one or more light-generating elements connected in series and/or in parallel to such terminals, and a typical example is a lamp with a plurality of LED elements.

There are many situations conceivable where it is desirable to monitor the operation of a lamp. This does not necessarily apply to situations where the lamp is used for illumination: if such lamp is defective, the user will note the absence of light in cases where he expects the lamp to be ON. Said desire applies specifically to situations where the lamp is used as an indicator or signaling lamp, especially where the lamp has a safety function. Signaling lamps are commonly used to signal a condition of an apparatus. Most people will recognize in their car the signaling function of the lamp signaling that they run out of petrol, or that the temperature of the engine is too high. Normally, such lamp is OFF, indicating that everything is normal; when such signaling lamp is ON, it indicates an error situation requiring action from a user. If such lamp fails, the user is not warned. In the examples mentioned, the consequences are mild (the car comes to a stop because of running out of petrol) or merely financial (the motor breaks down). However, there are situations where failure of a warning lamp can have disastrous consequences, for instance in the case of personnel handling dangerous machines, or for instance in the case of airplanes. Actually, there are many situations where the use of failsafe signaling lamps is even prescribed by safety regulations and/or legal provisions.

A failsafe lamp is provided with monitoring circuitry capable of detecting whether the lamp is in correct working order. The combination of the actual lamp and the monitoring circuitry will be indicated as failsafe lighting system.

Monitoring the lamp can be done in many ways. For instance, in the case of incandescent lamps, it is possible to monitor the impedance of the lamp filament, even when the lamp is OFF. Also when the lamp is ON and the temperature of the filament rises, causing a change of the filament impedance, the characteristic behavior of the filament impedance can be monitored. Such monitoring can detect a broken filament even before the lamp is switched ON. However, such approach is not possible in the case of LEDs, which are nowadays being used more and more as signaling lamps. Failure of a LED can occur in many ways and does not necessarily lead to an open circuit or a shorted circuit. So, a broken LED can pass current when a drive voltage is applied, so that electrically it looks fine, while actually it is not operating properly and produces no light.

Instead of monitoring the electrical properties of the lamp, it is possible to monitor the light output of the lamp. In such case, the monitoring circuitry may comprise a light detector and a comparator for comparing the measured light output with a preset light threshold: if the monitoring circuitry detects that the light output is less than expected, it produces a warning signal such as to alert a user. However, a problem is that the monitoring circuitry itself can fail. If a failing monitoring circuitry warns that the monitored signaling lamp is defective while it actually is not, that is just annoying. Oppositely, if a failing monitoring circuitry does not warn in case the monitored signaling lamp is actually defective, the above-mentioned serious consequences may occur. It is true that the chance that the signaling lamp and its monitoring circuitry are both defective is already much less than the chance of a failing signaling lamp alone. Nevertheless, the present invention aims to provide a failsafe lighting system with improved safety level.

### SUMMARY OF THE INVENTION

Particularly, the present invention aims to provide a failsafe lighting system, including a lamp and a lamp monitoring circuitry, capable of generating a warning signal in case of failure of the lamp and in case of failure of the monitoring circuitry, with a very high level of reliability.

In one aspect, the failsafe lighting system according to the present invention comprises a self-oscillation circuit, in which the lamp and a light sensor are incorporated. A failure of any of the components of the oscillation circuit, including the lamp, will prevent the circuit from oscillating. A detection circuit, which may be a remote detection circuit, detects the oscillation and generates an alarm in the absence of oscillation.

In a second aspect, a detection circuit comprises an electromechanical relais, and the oscillation circuit provides the power for the relais. An input section of the detection circuit comprises a transformer for receiving the AC power from the oscillation circuit. Thus, it is intrinsically assured that the relais can only be actuated by a correctly functioning oscillation circuit and cannot be actuated by any failure of any component.

In a third aspect, the relais terminals are wired in such a manner that a possible mechanical failure of the relais can be detected.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically showing the general design of a failsafe lighting system according to the present invention;

FIG. 2 is a block diagram schematically showing some more details of a lamp unit and a alarm unit;

FIG. 3 is a block diagram illustrating a possible embodiment of a lamp unit in more detail;

FIGS. 4A-4C illustrate a first embodiment of a fail-safe relais circuit;

FIGS. 5A-5C illustrate a second embodiment of a fail-safe relais circuit.

### DETAILED DESCRIPTION OF THE INVENTION

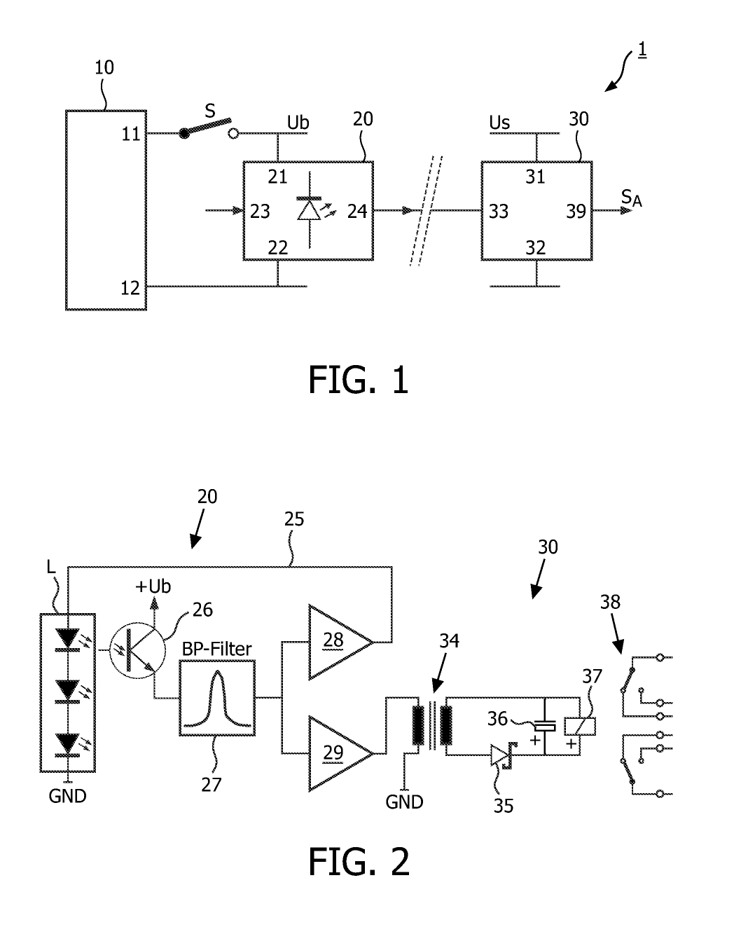

FIG. 1 is a block diagram schematically showing the general design of a failsafe lighting system 1 according to the present invention. The system 1 comprises a lamp unit 20 and an alarm unit 30. Depending on application, the alarm unit 30 may be accommodated in the same housing as the lamp unit 20, but the alarm unit 30 may also be located remote from the lamp unit 20, as illustrated.

The lamp unit 20 comprises at least one lamp L. Although the principles of the present invention can also be applied in case the lamp L is of incandescent type, the present invention is primarily intended for a lamp L implemented by one or more LEDs, as illustrated.

A power source for the lamp L is indicated by reference numeral 10. The power source has output terminals 11, 12 providing a DC bus voltage Ub. The lamp unit 20 has power input terminals 21, 22 coupled to the power source output terminals 11, 12. The lamp L may be switched ON/OFF by a switch S in one of the bus lines. It is also possible that the lamp unit 20 is constantly receiving power voltage and is switched ON/OFF by a control signal received at a control input terminal 23.

The lamp unit 20 has a monitor output terminal 24 coupled to an input terminal 33 of the alarm unit 30. The alarm unit 30 has power input terminals 31, 32 coupled a power supply bus receiving supply voltage Us; this may be but usually is not the same power supply as the lamp unit 20. The alarm unit 30 further comprises an output terminal 39 for outputting a lamp status indicating signal, or alarm signal, S_{A}. This signal can have two values for indicating that the monitored lamp L is either functioning properly, or not. The signal can for instance be in the form of a visual signal, an acoustical signal, or an electrical signal for processing by a signal processor, for instance a computer.

FIG. 2 is a block diagram schematically showing some more details of the lamp unit 20 and the alarm unit 30. The lamp unit 20 comprises, apart from the lamp L, a light sensor 26 that is mounted for receiving a portion of the light generated by the lamp L. An output signal of the sensor 26 is, preferably via a bandpass filter 27, fed back to the lamp L via an amplifier 28 such as to constitute a self-oscillation circuit 25. It is to be recognized that the oscillation circuit 25 can only form a closed loop, such as to be able to oscillate, if the path from lamp L to sensor 26 is closed, i.e. when the lamp L is generating sufficient light output.

Components for determining the oscillation frequency are not shown in FIG. 2 for sake of simplicity. It is noted that the precise value of the oscillation frequency is not critical, but should preferably be higher than 100 Hz such as to be not noticeable for the human eye. In a suitable embodiment, the oscillation frequency is in the order of about 20 kHz. It is further noted that the central pass frequency of the bandpass filter is adapted to the oscillation frequency.

The sensor 26 does not only act as monitoring element, monitoring the correct functioning of the lamp. Since the sensor 26 is incorporated in the self-oscillation circuit 25, the sensor 26 is essential in allowing the self-oscillation circuit 25 to oscillate. Actually, this applies to all components of the self-oscillation circuit 25: if any such component fails, the self-oscillation circuit 25 cannot oscillate. Thus, the correct functioning of all components of the self-oscillation circuit 25 is monitored intrinsically.

The alarm unit 30 is designed for monitoring the oscillation of the self-oscillation circuit 25. Essentially, the alarm unit 30 comprises an input transformer 34 having an input winding receiving an input AC power signal generated by the self-oscillation circuit 25, preferably via a second amplifier 29 so that the transformer 34 does not load the self-oscillation circuit 25. An output winding of the transformer 34 is connected in series with a diode 35 and a capacitor 36, and an actuation coil 37 of a relais 38 is connected in parallel to said capacitor 36. Thus, the relais 38 is actuated only when the transformer 34 transfers operating power, which the transformer 34 can only do when receiving alternating current from a correctly oscillating oscillation circuit 25. If the self-oscillation circuit 25 does not oscillate (or does not oscillate at the correct frequency or does not oscillate at sufficient amplitude), the output voltage of the transformer 34 will be insufficient for actuating the relais 38. It is not be noted that any failure in the lamp 20 leading to a short between the input winding of the transformer 34 can at worst connect the transformer to the constant voltage Ub, which cannot lead to power being transferred by the transformer.

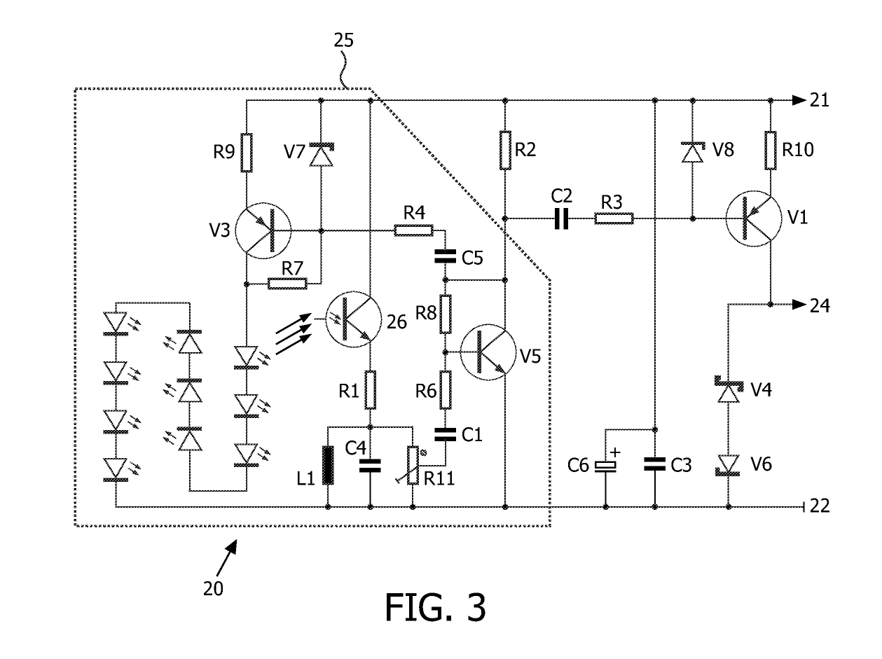

FIG. 3 is a block diagram illustrating a possible embodiment of the lamp unit 20 in more detail. The lamp L is in this case implemented as a series arrangement of LEDs, connected in series with a transistor V3 and a resistor R9 between the power input terminals 21, 22. Between the power input terminals 21, 22, the light sensor 26 is connected in series with a resistor R1 and a parallel arrangement of an inductor L1, a capacitor C4 and a variable resistive voltage divider R11 that is coupled to the base of a transistor V5. Via resistor R4 and capacitor C5, the transistor V5 is coupled to the base of transistor V3 to close the self-oscillating feedback loop 25. It can easily be seen that the feedback is constructive, i.e. an increase in light output leads to an increased sensor current, hence an increased voltage at the base of V5, hence an increased collector current of V5 and hence an increased increased collector current of V3. The parallel arrangement of inductor L1 and capacitor C4 determines the resonance frequency of the self-oscillating circuit 25. This parallel arrangement also acts as a bandpass filter. The variable resistive voltage divider R11 (which may also be a fixed-ratio resistive voltage divider) has the function of sensing the output voltage of the resonant parallel arrangement L1/C4 for further processing the signal towards amplifier 28.

In experiments, this setup has been tested. When one (or both) of the components L1 and C4 was cut open (i.e. replaced by a high impedance) or short circuited (i.e. replaced by a low impedance), this always resulted in the oscillation being stopped.

The circuit around transistor V1, having its base coupled to the collector of transistor V5, implements the second amplifier 29 providing the drive voltage for the transformer 34 of the alarm unit 30, with an amplitude limited by the series arrangement of Zeners V4 and V6. When comparing FIG. 3 with FIG. 2, one may consider the circuit around transistor V3 as implementing the first amplifier 28, having an input terminal coupled to the input terminal of second amplifier 29, in which case one could consider the circuit around transistor V5 as an additional amplifier not shown in FIG. 2, having its input coupled to the bandpass filter 27 and having its output coupled to the input terminals of first and second amplifiers 28 and 29. Alternatively, it is possible to consider the circuits around transistors V5 and V3 as constituting a two-stage implementation of first amplifier 28, in which case one would consider the second amplifier 29 as having its input terminal coupled to an intermediate node of this first amplifier 28.

It can easily be seen that amplifier 29 can only produce an AC output voltage if coupling capacitor C2 passes an alternating signal, i.e. if the self-oscillating circuit 25 is oscillating.

Regarding the relais, there is also the possibility that the relais fails, for instance because its contacts stick together. The present invention also provides a solution for detecting such failures.

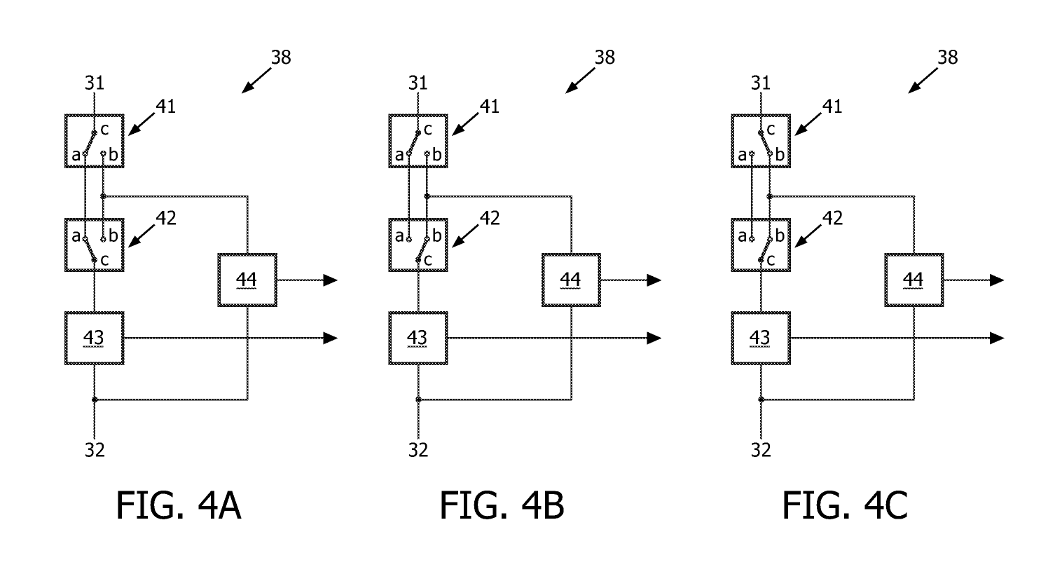

FIGS. 4A-4C illustrate a first embodiment. The relais 38 has two sets of contacts 41, 42 with respective contact arms. Each set has a central contact c, a first contact a and a second contact b. The central contact c of the first set 41 is connected to first input terminal 31, while the central contact c of the second set 42 is connected to second input terminal 32 via a first voltage sensor 43. The two first contacts a are connected together, and the two second contacts b are connected together. A second voltage sensor 44 is connected between the second input terminal 32 and the two second contacts b. Both voltage sensors generate an output signal, as indicated by horizontal arrows, for direct observation by a user of for processing by a signal processor or the like.

If the relais is in an non-actuated rest condition, the two contact arms connect the central contact c with the first contact a (FIG. 4A). The first voltage sensor 43 senses the full input voltage Us, while the second voltage sensor 44 does not sense any voltage. This is a situation indicating that the lamp L is OFF, either deliberately or through failure, or that the relais 38 is failing by being stuck in the non-activated condition, for instance because the relais coil is broken.

If the relais is actuated, the two contact arms connect the central contact c with the second contact b (FIG. 4C). Now both voltage sensors 43 and 44 sense the full input voltage Us. This is a situation indicating a correct functioning of the lamp L.

If one of the relais contact arms gets stuck in an incorrect position (FIG. 4B), the first voltage sensor 43 does not sense any voltage. This is a situation indicating an incorrect functioning of the relais 38.

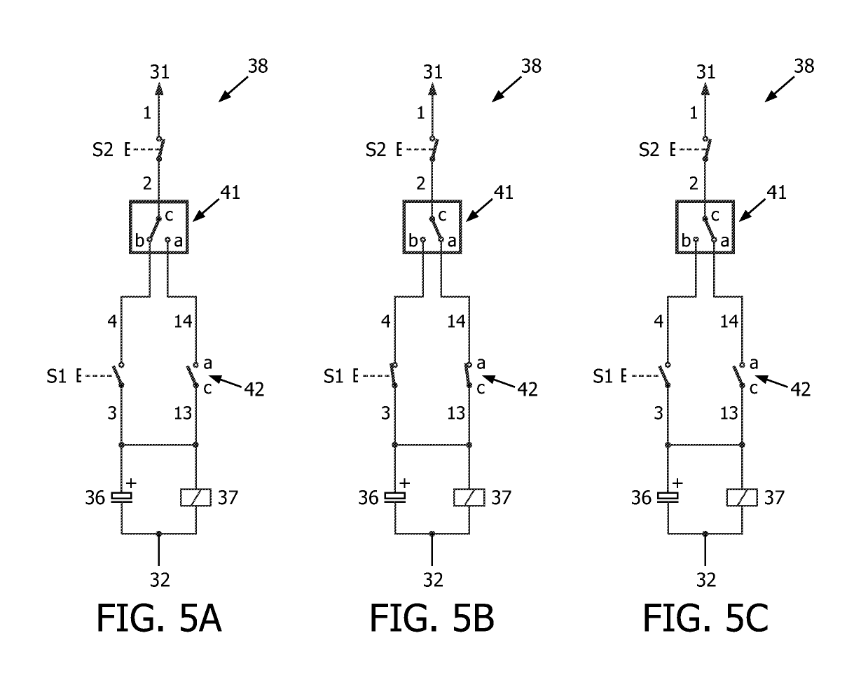

FIGS. 5A-5C illustrate a second embodiment. FIG. 5A shows the relais 38 in the off condition. When the start switch S1 is pressed, the relais coil 37 is actuated, and the relais contacts switch over to a position where they provide a path for holding current for the relais (FIG. 5B); the start switch S1 can now be released. When the stop switch S2 is pressed, the circuit is broken and the relais 38 returns to the condition of FIG. 5A; the stop switch can now be released without the relais being actuated. However, when contacts 41 are stuck (FIG. 5C), pressing the start switch S1 has no effect. If both contacts 41 and 42 would get stuck, the relais would be actuated immediately when the stop switch is released.

Summarizing, the present invention provides a failsafe lighting system comprising a lamp and monitoring circuitry for monitoring the correct functioning of the lamp, the monitoring circuitry comprising an optical sensor positioned for receiving light generated by the lamp.

According to the present invention, the monitoring circuitry comprises a self-oscillating loop which includes the lamp and the optical sensor, wherein the optical path between the lamp and the optical sensor is an essential portion of the loop such that the loop can only oscillate if the optical sensor receives sufficient light from the lamp. While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, in FIG. 2, the relative order of bandpass filter 27 and amplifier 28 is not essential. Also, the second amplifier 29 may be coupled to the loop 25 at another location, for instance at the output of the first amplifier 28.

Further, it is possible that the alarm unit and the lamp unit are integrated, but it is also possible that the alarm unit is located remote.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. Failsafe lighting system, comprising:
a lamp (L);
monitoring circuitry for monitoring the correct functioning of the lamp (L), the monitoring circuitry comprising an optical sensor positioned for receiving light generated by the lamp (L); wherein the monitoring circuitry comprises a self-oscillating loop which includes an optical path between the lamp (L) and the optical sensor such that the loop can only oscillate if the optical sensor receives light from the lamp (L).

2. Failsafe lighting system according to claim 1, wherein the self-oscillating loop includes an amplifier.

3. Failsafe lighting system according to claim 1, wherein the self-oscillating loop includes bandpass filtering means.

4. Failsafe lighting system according to claim 1, wherein failure of any component of the self-oscillating loop will prevent the self-oscillating loop from oscillating.

5. Failsafe lighting system according to claim 1, wherein the monitoring circuitry further comprises an alarm unit, including an electromechanical relay and a transformer (34) having a secondary winding coupled to a relais coil for actuating the relais, wherein the transformer has a primary winding coupled to the self-oscillating loop for receiving an input AC power signal derived from the self-oscillating loop when oscillating.

6. Failsafe lighting system according to claim 5, further comprising an amplifier coupled between the self-oscillating loop and the transformer.

7. Failsafe lighting system according to claim 1, wherein the relay comprises two sets of contacts interconnected for detecting a failure.

8. Failsafe lighting system according to claim 7, wherein each set has a central contact (c), a first contact (a) and a second contact (b), wherein the relais has a rest condition in which respective arms connect each central contact (c) with the corresponding first contact (a), and wherein the relais has an actuated condition in which the respective arms connect each central contact (c) with the corresponding second contact (b);
wherein the two first contacts (a) are connected together, and the two second contacts (b) are connected together;
wherein the central contact (c) of the first set is connected to a first input terminal, while the central contact (c) of the second set is connected to a second input terminal via a first voltage sensor;
wherein a second voltage sensor is connected between the second input terminal and the two interconnected second contacts (b);
and wherein the two input terminals are connected to a power supply (Us).
